(19) United States
(12) Patent Application Publication
(10) Pub. No.: US 2010/0225564 A1
(43) Pub. Date: Sep. 9, 2010

(54) IMAGE DISPLAY DEVICE

(75) Inventors: Isao Tomisawa, Tokorozawa-shi (JP); Masaru Ishikawa, Tokorozawa-shi (JP); Ichiro Miyake, Tokorozawa-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/279,901

(22) PCT Filed: Feb. 13, 2007
(86) PCT No.: PCT/JP2007/052499

§ 371 Date: Sep. 3, 2008

(30) Foreign Application Priority Data
Feb. 21, 2006 (JP) 2006-043532

(51) Int. Cl. G09G 5/00

(52) U.S. Cl. 345/1.3

(57) ABSTRACT

An image display device includes plural display elements with display screens on which two-dimensional images are displayed. Optical paths of display light for forming the two-dimensional images are disposed to overlap each other. An image transmission panel is provided on the optical paths for transmitting the display light to display the two-dimensional images in a space on a side opposite to the display screens. An image pickup element is integrated with the display screens of the display element or provided in the vicinity of the display screens for picking up images of objects entering the space through the display panel. The image display device has a position specifying element for specifying positions of the picked-up objects in accordance with results of the images picked up by the image pickup element, and an image control element for controlling the display element to switch the two-dimensional images based on the specified positions.

### TECHNICAL FIELD

The present invention relates to an image display apparatus capable of displaying a stereoscopic two-dimensional image and suitable for specification of the position of a detected object, which enters a space in which the stereoscopic two-dimensional image is displayed.

### BACKGROUND ART

As this type of image display apparatus, for example, there is a proposed technology in which a display apparatus, which displays a two-dimensional image, and an optical panel, on which the real image of the two-dimensional image is formed in a space ahead of the display apparatus, are provided and in which the two-dimensional image is stereoscopically displayed with respect to a viewer in the space ahead (i.e. a technology of displaying a stereoscopic two-dimensional image) (refer to a patent document 1). The image display apparatus is further provided with a position detection sensor for outputting an output signal corresponding to the position of a detected object, which is inserted into the space, in order to detect the detected object inserted into the space ahead.

Patent Document 1: Japanese Patent Application Laid Open No. 2005-141102

### DISCLOSURE OF INVENTION

### Subject to be Solved by the Invention

However, for example, according to the technology disclosed in the patent document 1 described above, the position detection sensor is, for example, frame-shaped to surround the space ahead and is possibly an obstacle to reduce the size of the entire apparatus. In particular, it may relatively reduce a capability to exercise ingenuity in the image display apparatus itself, such as improving the embossing effect and the element of surprise of the stereoscopic two-dimensional image.

In view of the aforementioned problems, it is therefore an object of the present invention to provide an image display apparatus capable of displaying a stereoscopic two-dimensional image and suitable for preferable specification of the position of a detected object, which enters a space in which the stereoscopic two-dimensional image is displayed, relatively easily.

### Means for Solving the Subject

(Image Display Apparatus)

The above object of the present invention can be achieved by an image display apparatus provided with: a plurality of displaying devices, each displaying device having a display screen, each displaying device displaying a two-dimensional image on the display screen, the display devices being arranged such that optical paths of display lights, which constitute the two-dimensional image, overlap each other; an image transfer panel disposed on the optical paths and transmitting the display light so as to display an image of the two-dimensional image in a space on an opposite side to the display screen; an imaging device disposed integrally with or adjacent to the display screen, which is owned by each of the plurality of display devices, the imaging device imaging a detected object which enters the space through the image transfer panel; a position specifying device for specifying a position in the space of the imaged detected object, on the basis of a result of the imaging by the imaging device; and an image controlling device for controlling the plurality of display devices to change the two-dimensional images, on the basis of the specified position.

According to the present invention, each of the displaying devices has the display screen for displaying the two-dimensional (2D) image; and the imaging device disposed integrally with or adjacent to the display screen and imaging the detected object which enters the space in which the image is displayed, through the image transfer panel. Typically, the displaying device is formed of a so-called “input display panel”. More specifically, the displaying devices include, for example, charge coupled devices (CCD) for imaging; and a color liquid crystal display (LCD) for display, which are arranged on substantially the same plane. The plurality of displaying devices as described above are arranged such that the optical paths of their display lights overlap each other. Incidentally, “disposed integrally” means that a member constituting the “display screen” owned by the displaying device and a member constituting the imaging device are common at least partially, and that the display screen or the imaging device cannot be removed from the displaying device while maintaining the both functions of display and imaging. Moreover, in the present invention, “disposed adjacent” includes a case where the member constituting the display screen and the member constituting the imaging device are side by side on the same plane which crosses the optical path of the display light and a case where the above members are in contact with or close to each other along the optical path, and it means that the distance between the display screen and the imaging device in the same displaying device is apparently less than the distance along the optical path between the plurality of displaying devices.

In its operation, each 2D image is displayed on the display screen by respective one of the plurality of displaying devices. Here, the “2D image” conceptually includes not only a still image but also a moving image displayed on the display screen which is two-dimensional, i.e. plane.

If the plurality of 2D images are displayed as described above, the image transfer panel in which, for example, convex lenses are arrayed, forms and displays the image corresponding to each 2D image on each imaging plane corresponding to each display screen position, located in the space on the opposite side to the display screen viewed from the image transfer panel. The image transfer panel includes, for example, a convex lens array, and it is possible to use a panel of such a type that a plurality of convex lenses are arranged in a vertical and horizontal matrix with their optical paths being substantially parallel, i.e. an image transfer panel for 3D floating vision (a registered trademark of the present inventors) method. As described above, the image on each imaging plane constitutes a stereoscopic 2D image. Here, the “stereoscopic 2D image” is an image which seems as if it floated in the air for a viewer, and it is formed of a real image formed by the image transfer panel. For example, in the aforementioned 3D floating vision method, the stereoscopic 2D image is formed of a real image formed by the convex lens array. Moreover, particularly in the present invention, a plurality of stereoscopic 2D images construct stereoscopic 2D images which are more stereoscopic. That is, the plurality of the stereoscopic 2D images that seem to float in the air are seen at different positions.

When the aforementioned stereoscopic 2D images are displayed, if the detected object, such as a viewer's finger, enters the space in which the stereoscopic 2D image is displayed, the detected object is imaged by the imaging devices through the image transfer panel. Here, “imaging” or “to image” typically means, but is not limited to, high-resolution imaging, such as shooting with a camera, but also includes such a meaning that it is only necessary to take an image related to the detected object at an extremely low resolution or in some sense. In any cases, the light from the detected object is imaged by the imaging devices as the image corresponding to each imaging plane. Here, in particular, since the imaging device is disposed integrally with or adjacent to the display screen, it is possible to find the in-plane position of the detected object on each of the imaging planes arranged in the space in which the stereoscopic 2D image is displayed. It is also possible to find the degree of focus of the detected object on each imaging plane. That is, it is possible to find at which in-plane position the detected object is located on each imaging plane, and it is also possible to find on which imaging plane or relatively near which imaging plane the detected object is located. Moreover, the “position” herein is not limited to a static position, but it can be also found even in a dynamic position (e.g. a motion trajectory up to now), such as a case where the detected object is displaced.

If the imaging is performed, then the position specifying device including e.g. a CPU (Central Processing Unit) and a memory, evaluates the position of the imaged detected object and the sharpness of an edge or the like by image processing, such as pattern recognition, on the basis of an imaging result, to thereby specify the position in the space of the detected object. Here, the “position” is a comprehensive concept including not only a literal position but also an area occupied by the detected object in the space, or a temporal change in position (i.e. velocity and direction). As described above, the position specifying device can specify the position in the space of the detected object, extremely certainly.

Then, on the basis of the specified position in the space of the detected object, the image controlling device including e.g. a CPU and a memory controls the plurality of displaying devices to change the 2D images which are currently displayed. For example, the content of how to change the plurality of 2D images is defined in advance on a control table if the detected object is specified to be located at a predetermined position in the space, and the plurality of 2D images displayed on the plurality of displaying devices are changed on the basis of the control table. As a result, the following control is performed. For example, it is assumed that a viewer's finger enters the space in which the plurality of stereoscopic 2D images are displayed. At this time, if the position in the space of one portion (e.g. button image) of a certain stereoscopic 2D image of the plurality of images substantially matches the position in the space of the finger on the basis of the position in the space of the finger, it is considered that the button image is pressed by the finger. Then, on the basis of the control table, the stereoscopic 2D image displaying the button image is changed to a side getting away from the finger or to a side approaching the finger. As described above, the display content of the stereoscopic 2D images arranged in tandem is changed in accordance with the specified detected object, which improves expressivity in a depth direction and which allows more effective and interactive presentation.

Incidentally, when the 2D image is changed as described above, if at least one portion of the stereoscopic 2D image corresponding to the changed 2D image relatively moves away from the detected object, the image controlling device may control the plurality of displaying devices so as to relatively reduce the size of the at least one portion. In contrast, if at least one portion of the stereoscopic 2D image corresponding to the changed 2D image relatively approaches the detected object, the image controlling device may control the plurality of displaying devices so as to relatively increase the size of the at least one portion.

By virtue of such construction, when the detected object enters or comes in contact with at least one portion (e.g. button image) of the stereoscopic 2D image corresponding to one 2D image of the plurality of 2D images, if the at least one portion, which is entered or contacted by the detected object, relatively moves away from the detected object, the image controlling device controls the plurality of displaying devices to relatively reduce the size of the at least one portion. For example, it is assumed that a button image is displayed as at least one portion of the stereoscopic 2D image and that a viewer touches the button image. At this time, if the stereoscopic 2D image displaying the button image is displayed on the near side (or front side) of an original position viewed from the viewer, the button image itself displayed by the displaying devices is relatively increased, and on the other hand, if the stereoscopic 2D image is displayed on the rear side (or back side) of the original position, the button image itself displayed by the displaying devices is relatively reduced, both of which allow an expression that provides emphasized perspective. For example, it is possible to provide such an expression that the stereoscopic 2D image which seems to float in the air moves backward when a viewer presses the button image of the stereoscopic 2D image and also such an expression that even if nothing is displayed, if a viewer brings the finger closer to where the position is specified by the position specifying device (including not only a case where it is in contact with the imaging plane but also a case where it is recognized as a taken image regardless of defocus, i.e. a case where the detected object approaches the imaging plane), a character of the stereoscopic 2D image which seems to float in the rear viewed from the viewer seems to approach forward. In addition, it is also possible to add an effect associated with another element, depending on the position of the detected object. For example, on the basis of the position in the space of the specified detected object, the 2D image to be displayed may be deformed (e.g. dent), or sound effects may be enabled. In this manner, a richer expression can be provided.

Consequently, according to the present invention, it is possible to preferably specify the position of the detected object which enters the space in which the stereoscopic 2D image is displayed, while typically using a relatively simple structure of a plurality of input display panels. By this, a reduction in cost for the entire image display apparatus, or a reduction in size and thickness is also expected. In addition, the display content of the stereoscopic 2D images arranged in tandem is changed in accordance with the specified detected object, which improves expressivity in a depth direction and which allows more effective and interactive presentation.

In an aspect provided with the position specifying device, the position specifying device may specify an in-plane position on an imaging plane on which the image is formed, in the space of the imaged detected object.

By virtue of such construction, the position specifying device can certainly specify at which in-plane position on each imaging plane (e.g. a 2D coordinate position on each imaging plane which is perpendicular to the optical path) the detected object is located.

In an aspect provided with the position specifying device, the position specifying device may specify a position in a direction along the optical path, in the space of the imaged detected object.

By virtue of such construction the position specifying device can certainly specify on which imaging plane or relatively near which imaging plane (e.g. a coordinate position in the direction along the optical path) the detected object is located.

In this aspect, the position specifying device may specify the position in the space of the detected object, on the basis of a focus estimation element in a result of imaging the detected object.

By virtue of such construction, the position specifying device can specify the position of the detected object in a vertical (z) direction with respect to the taken image, i.e. the position in the space of the detected object, on the basis of not only planar position information about the detected object in the taken image (e.g. xy coordinates of the detected object in the taken image) but also the focus estimation element of the detected object (e.g. the degree of focus, i.e. not only a quantitative index indicating whether or not to be focused, such as the sharpness of an edge, but also a change in size or shape of the detected object in the taken image). In particular, not one but by comparing focus estimation elements of a plurality of taken images, it is possible to specify the position in the space of the detected object and its moving direction, more accurately. For example, even if it is tried to specify the position of the detected object only from the focus estimation element of one taken image, unless it is focused (i.e. if it is defocused), defocus occurs to the same degree even if the detected object is shifted either to front or to rear. Thus it is hard to judge in which direction the detected object is shifted. According to this aspect, however, since the focus estimation element of another taken image can be also considered, it is possible to judge in which direction in the taken image the detected object is shifted by specifying another taken image which is focused, and it is possible to specify the position of the detected object in the vertical (z) direction with respect to the taken image, i.e. the position in the space of the detected object.

In this case, moreover, the position specifying device may specify an operation in addition to the position in the space of the detected object, on the basis of a temporal change in the focus estimation element of the detected object, in the taken image.

By virtue of such construction, it is possible to specify not only the position in the space of the detected object but also the operation, due to the temporal change in the focus estimation element of the detected object (such as being gradually focused). For example, by comparing the temporal changes in the focus estimation elements of the detected object in adjacent taken images, it is possible to judge whether the detected object approaches or moves away from the stereoscopic 2D image corresponding to a certain taken image.

In another aspect of the image display apparatus of the present invention, the plurality of displaying devices can transmit light at least partially and overlap at predetermined distance intervals in a direction along the optical path.

According to this aspect, since the displaying devices can transmit the light at least partially, such as a transmissive organic EL panel and a transmissive liquid crystal panel, it is possible to display the stereoscopic 2D images with a stereoscopic effect corresponding to the arrangement interval of the plurality of displaying devices, using such a relatively simple structure that the displaying devices are arranged to overlap along the optical path, and it is also possible to preferably specify the position of the detected object which enters the space in which the stereoscopic 2D image is displayed.

Alternatively, in another aspect of the image display apparatus of the present invention, it is further provided with a light combining/dividing device for combining the display lights traveling toward the image transfer panel from each of the display screens and for dividing light traveling toward each the imaging device from the detected object.

According to this aspect, for example, after the light combining/dividing device, such as a half mirror, a prism, and a beam splitter, combines the display lights, the image transfer panel displays the image corresponding to each 2D image on each imaging plane, to thereby display the stereoscopic 2D image. Moreover, after the light combining/dividing device divides the light from the detected object, the imaging device images it as the image corresponding to each imaging plane. As described above, it is possible to display the stereoscopic 2D images with a stereoscopic effect corresponding to a difference in the optical distance between each displaying device and the image transfer panel, using a relatively simple structure of the light combining/dividing device. In particular, the degree of freedom of optical layout (arrangement) increases. In addition, for example, such an arrangement that the light forming one 2D image goes around the displaying device displaying another 2D image can be made, and another displaying device does not always have to transmit the light. That is, it allows a wide variety of options for a device which realizes the displaying device. Incidentally, as the arrangement of the plurality of displaying devices, it is also possible to mix the arrangement according to this aspect and another arrangement (e.g. the arrangement that the transmissive display apparatuses overlap, as described in the previous aspect).

In another aspect of the image display apparatus of the present invention, at least one portion of the plurality of displaying devices is of a non-light-emitting type and can transmit light at least partially, and the image display apparatus is further provided with a backlight for emitting light toward the at least one portion from an opposite side to the image transfer panel.

According to this aspect, if the plurality of displaying devices can transmit the light at least partially even if at least one portion is of a non-light-emitting type, it is possible to display the plurality of 2D images by using the light emitted from the backlight. In particular, if the plurality of displaying devices are arranged to overlap on the same path, one backlight can be shared by the plurality of displaying devices, which reduces cost.

In another aspect of the image display apparatus of the present invention, at least one portion of the plurality of displaying device is of a light-emitting type.

According to this aspect, since at least one portion of the plurality of displaying devices is of a light-emitting type, such as an organic EL, the backlight is not required for the one portion, and it is unnecessary to consider where to dispose the backlight. That is, the degree of freedom of arrangement of the displaying devices increases. Incidentally, it is also possible to combine the light-emitting type and the non-light-emitting type.

As explained above, according to the image display apparatus of the present invention, it is provided with the displaying devices, the image transfer panel, and the imaging device. Thus, the image display apparatus can display the stereoscopic 2D image, and it can be further said that it is suitable for preferable specification of the position of the detected object which enters the space in which the stereoscopic 2D image is displayed.

These effects and other advantages of the present invention will become more apparent from the embodiments explained below.

### BRIEF DESCRIPTION OF DRAWINGS

FIG. 1 is a schematic cross sectional view conceptually showing the basic structure of an image display apparatus and an enlarged plan view showing a display device and an imaging device, in a first embodiment of the present invention.

FIG. 2 is a schematic diagram conceptually showing a plurality of images taken before a detected object is displaced, in the first embodiment.

FIG. 3 is a schematic diagram conceptually showing a plurality of images taken after the detected object is displaced, in the first embodiment.

FIG. 4 is a perspective view conceptually showing a stereoscopic two-dimensional image before the detected object enters, in the first embodiment.

FIG. 5 is a perspective view conceptually showing the stereoscopic two-dimensional image after the detected object enters, in the first embodiment.

FIG. 6 is a schematic diagram conceptually showing the basic structure of an image display apparatus in a second embodiment of the present invention.

### DESCRIPTION OF REFERENCE CODES

1 image display apparatus
11 input display panel
11A display device
11B imaging device
12 input display panel
13 input display panel
20 convex lens array
31 stereoscopic two-dimensional image
32 stereoscopic two-dimensional image
33 stereoscopic two-dimensional image
40 backlight
51 polarizing plate
53 polarizing plate
100 image control device
110 position specification device
120 detected object
121 detected object
122 detected object
111MG taken image
121MG taken image
131MG taken image
123 detected object
112D two-dimensional image of button
313D stereoscopic two-dimensional image of button
122D two-dimensional image of button
323D stereoscopic two-dimensional image of button
11s input display panel
12s input display panel
60 half mirror

### BEST MODE FOR CARRYING OUT THE INVENTION

Hereinafter, the best mode for carrying out the invention will be explained in each embodiment in order, with reference to the drawings.

### (1) First Embodiment

The basic structure and operation process of an image display apparatus in a first embodiment will be described with reference to FIG. 1. FIG. 1 is a schematic cross sectional view conceptually showing the basic structure of the image display apparatus and an enlarged plan view showing a display device and an imaging device, in the first embodiment of the present invention. In FIG. 1, an optical axis direction is set to a z direction, and a plane perpendicular to the z direction is set to an xy plane.

As shown in FIG. 1, an image display apparatus 1 in the embodiment is provided with: an input display panel 11; display devices 11A and imaging devices 11B provided for the input display panel 11; a convex lens array 20; a backlight 40; polarizing plates 51 and 53; an image control device 100; and a position specification device 110. The image display apparatus 1 is used as an apparatus for displaying and recognizing an interactive stereoscopic two-dimensional (2D) image, which is used for, for example, an amusement theater, a display for item description, game equipment, and the like.

Each of the input display panels 11, 12, and 13 is provided with a screen in which pixels including the display devices 11A and the imaging devices 11B are arranged in a matrix of e.g. 640×480, and the input display panels are disposed separately in a multilayer way on one optical axis extending toward the convex lens array 20.

Here, the display device 11A constitutes one example of the “display screen” owned by the “displaying device” of the present invention, and includes, for example, a color liquid crystal display apparatus (LCD). The plurality of display devices 11A arranged in a matrix allow a stereoscopic 2D image to be displayed on each screen. The display device 11A may be another type of display, for example, an organic EL display apparatus, if it is of a transmission type, due to the limitations of multilayer arrangement.

Here, the imaging device 11B is one example of the “imaging device” owned by the “displaying device” of the present invention, and includes, for example, a CCD. The imaging device 11B is provided integrally with the individual one of the plurality of display devices 11A or adjacent to the display screen. Then, the imaging device 1113 receives light from the detected object 120 and generates the taken image of the detected object 120. More specifically, on the imaging device 11B, the received light is converted into electricity from light as the image data of each of red, blue, and green, for example, to generate an image signal indicating the color taken image.

Incidentally, the number of the input display panels is set to three for convenience; however, the number is not limited to this. That is, in view of a light attenuation factor or a polarization direction or the like, the number of the input display panels can be further increased to provide more multilayer expression.

The convex lens array 20 is one example of the “image transfer panel” of the present invention. Typically, as in a 3D floating vision (a registered trademark of the present inventors) method, a plurality of convex lenses are arranged in a vertical and horizontal matrix such that their optical axes are substantially parallel to each other. Then, for example, while display light from the input display panel 11 side is transferred to a stereoscopic 2D image 31 side, light from the stereoscopic 2D image 31 side is transferred to the input display panel 11 side.

The stereoscopic 2D image 31, a stereoscopic 2D image 32, and a stereoscopic 2D image 33 are images (typically, same size erected images) obtained by forming the 2D images displayed on the screens of the input display panels 11, 12, and 13, in the air. The stereoscopic 2D images are actually planar, but since they seem to float in the air, a viewer can feel the 2D images stereoscopically. That is why they are referred to as stereoscopic 2D images. Moreover, particularly in the embodiment, there are the plurality of images floating in the air located on imaging planes different from each other. Thus, it can be said that more stereoscopic image display is performed. In addition, the stereoscopic 2D image is a plane on which the position of the detected object 120 is specified.

The backlight 40 includes, for example, a light-emitting diode. If each display device including the display devices 11A is of a non-light-emitting type, the backlight 40 emits the display light from back surface as an external light source. Incidentally, if each display device is of a light-emitting type, the backlight 40 is not required.

The polarizing plates 51 and 53 are provided for the back surface of the input display panel 11 (on the backlight 40 side) and the surface of the input display panel 13 (on the convex lens array 20 side), respectively, if the display device is a liquid crystal display apparatus. Moreover, in view of the polarization direction, the more polarizing plates can be disposed; for example, the polarizing plates can be also disposed on the surface and back surface of all the display devices. Incidentally, if each display device is not a liquid crystal display apparatus, the polarizing plates 51 and 53 are not required.

The image control device 100 is one example of the “image controlling device” of the present invention, and it is provided, for example, with a CPU, a memory, and an image display driver. The image control device 100 is electrically connected to each of the display devices arranged in a vertical and horizontal matrix, like the display devices 11A. The image control device 100 is adapted to supply each display device with a video signal for displaying the 2D image.

The detected object 120 is, for example, an actual ball or a viewer's finger, and it is a target whose position is specified by the position specification device 110.

The position specification device 110 is one example of the “position specifying device” of the present invention, and is provided, for example, with a CPU and a memory. The position specification device 110 specifies the position in the space of the detected object 120, on the basis of the plurality of taken images. Specifically, when the detected object 120 enters the space in which the stereoscopic 2D image 31 is displayed, a received light signal is obtained by the imaging devices 11B or the like, and the position specification device 110 specifies the position in the space of the detected object 120 on the basis of the plurality of taken images generated by the received light signal. In particular, in the present invention, since the plurality of input display panels are arranged in a depth direction, it is possible to specify the position, more accurately, in view of the focus evaluation element of the detected object in each input display panel, in addition to planar position information about the detected object 120 (e.g. the xy coordinates of the detected object in the taken image). In addition, the position specification device 110 may supply the image control device 100 with information about the specified position of the detected object 120 as an electric signal. The image control device 100 may change the 2D image or display a new image, on the basis of the position specified in the above manner.

The image display apparatus constructed in the above manner operates as follows, for example. Firstly, the image control device 100 supplies the video signal from the input display panel 11 to the input display panel 13. On the basis of the supplied video signal, the display devices of each input display panel display the 2D image. At this time, if the display device is not of a light-emitting type, the backlight 40 emits the display light from the back surface. Then, the display light is formed through the convex lens array 20, and the stereoscopic 2D image 33 is displayed in the air from the stereoscopic 2D image 31. As described above, since there are the plurality of images floating in the air located on the imaging planes different from each other, it can be said that the more stereoscopic image display is performed in a viewer's eyes. In addition, for example, if the detected object 120, such as a viewer's finger, enters the imaging plane of the stereoscopic 2D image 31, the light from the detected object 120 is recognized as the taken image by the imaging devices 11B of the input display panel (in this case, the input display panel 11) corresponding to the imaging plane through the convex lens array 20. Then, the position specification device 110 can specify the position in the space of the detected object (i.e. the xyz coordinates of the detected object), more accurately, in view of the taken image or the like related to another input display panel, as well as the xy coordinates of the detected object in the taken image and the focus evaluation element. Moreover, on the basis of the specified position, the image control device 100 may change the 2D image to be displayed.

As described above, as shown in FIG. 1, the image display apparatus in the embodiment can display the stereoscopic 2D image, and moreover, it can preferably detect the position of the detected object which enters the space in which the stereoscopic 2D image is displayed, on the basis of not one taken image but the plurality of taken images. Thus, the image display apparatus can display the stereoscopic 2D image that is more interactive and rich in expression.

<<As for Change in the Taken Image when the Detected Object is Displaced>>

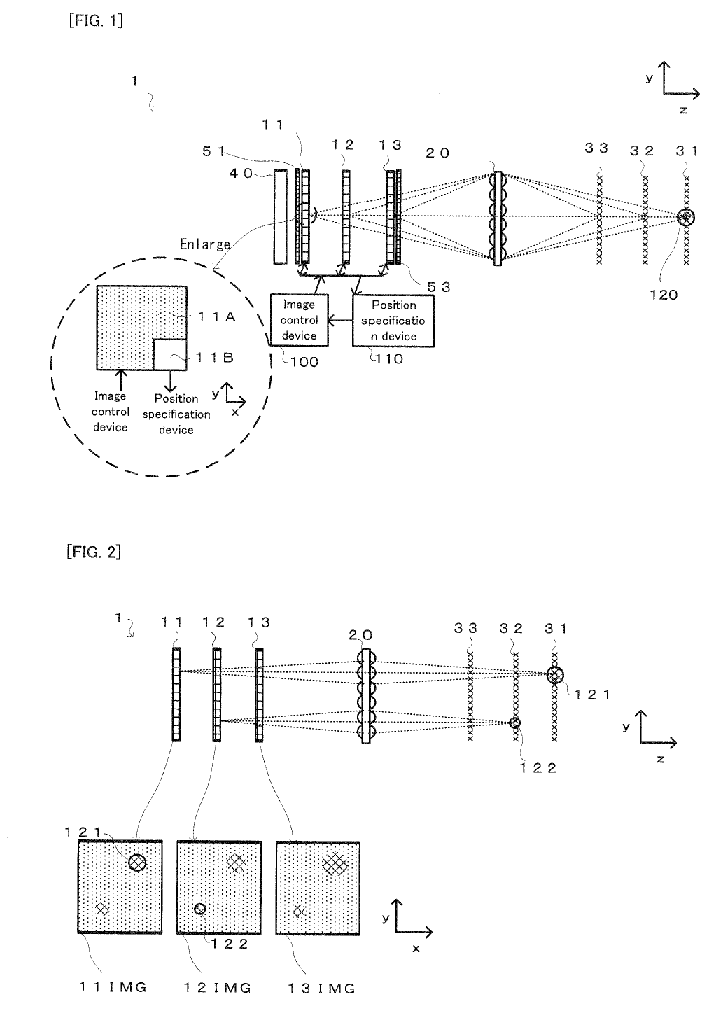

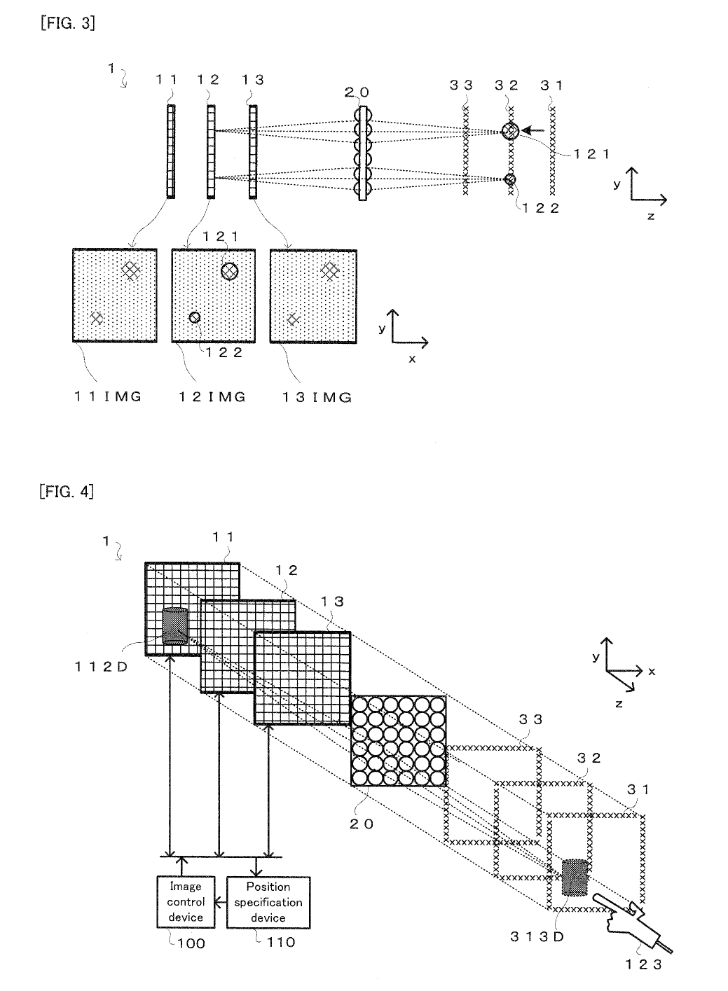

Next, a change in the taken image when the detected object is displaced in the embodiment will be described with reference to FIG. 2 and FIG. 3. Incidentally, in FIG. 2 and FIG. 3, the same structure as that of FIG. 1 carries the same numerical reference, and the detailed explanation thereof will be omitted, as occasion demands. FIG. 2 is a schematic diagram conceptually showing the plurality of images taken before the detected object is displaced, in the first embodiment.

In FIG. 2, taken images 111MG, 121MG, and 131MG indicates taken images related to the input display panels 11, 12, and 13 before a detected object 121 is displaced, respectively. If a plurality of such taken images are obtained, the z coordinates can be specified from the focus evaluation element (here, the size of the images and the sharpness of edges in the detected objects 121 and 122), in addition to the xy coordinates of the images of the detected objects 121 and 122, in each taken image. For example, from the taken images shown in FIG. 2, because 111MG has the sharpest edge of the image of the detected object 121 and 121MG has the sharpest edge of the image of the detected object 122, it is possible to specify that the detected object 121 is on the stereoscopic 2D image 31 and that the detected object 122 is on the stereoscopic 2D image 32. Moreover, from the fact that focus deteriorates gradually and the size increases from 121MG to 131MG as compared to 111MG in the image of the detected object 121, it can be also specified that the detected object 121 is on the stereoscopic 2D image 31. In the same manner, in the image of the detected object 122, from the fact that 111MG and 131MG have substantially the same change in focus and substantially the change in size as compared to 121MG, it can be also specified that the detected object 122 is on the stereoscopic 2D image 32.

Next, FIG. 3 is a schematic diagram conceptually showing the plurality of images taken after the detected object is displaced, in the first embodiment.

In FIG. 3, what is different from FIG. 2 is the position of the detected object 121. This difference in position can be specified by comparing the edges of the images of the detected object 121 in the taken images. Specifically, since 121MG has the sharpest edge of the detected object 121, it can be specified that the detected object 121 is on (or near) the imaging plane of the stereoscopic 2D image 32. As a result, it can be estimated that the detected object 121 is displaced in the z direction, from the stereoscopic 2D image 31 to the stereoscopic 2D image 32.

As explained above using FIG. 2 and FIG. 3, the image display apparatus 1 in the embodiment can specify the positions in the space of the detected object 121 and the detected object 122. In addition, on the basis of a temporal change in the focus estimation element of the detected objects 121 and 122, not only the position in the space but also the operation can be specified.

<<As for a Change in the Stereoscopic 2D Image when the Detected Object Enters>>

Next, a change in the stereoscopic 2D image when the detected object enters in the embodiment will be described with reference to FIG. 4 and FIG. 5. Incidentally, in FIG. 4 and FIG. 5, the same structure as those of the aforementioned drawings carries the same numerical reference, and the detailed explanation thereof will be omitted, as occasion demands. FIG. 4 is a perspective view conceptually showing the stereoscopic two-dimensional image before the detected object enters, in the first embodiment.

In FIG. 4, the detected object 123 is, for example, a viewer's finger, and it hasn't entered the stereoscopic 2D image 31 yet.

A 2D image 112D of a button is a certain object (e.g. button) displayed on the screen of the input display panel 11.

A stereoscopic 2D image 313D of the button is a real image of the 2D image 112D of the button formed by the image transfer panel.

Next, FIG. 5 is a perspective view conceptually showing the stereoscopic two-dimensional image after the detected object enters, in the first embodiment.

In FIG. 5, what is different from FIG. 4 is the position of the detected object 123, the position of a 2D image 122D of the button changed in accordance with the position of the detected object 123, and the position of a stereoscopic 2D image 323 of the button.

Specifically, the detected object 123 in FIG. 5 indicates, for example, that a viewer's finger enters the stereoscopic 2D image 31.

The 2D image 122D of the button is a certain object (e.g. button) displayed on the screen of the input display panel 12.

A stereoscopic 2D image 323D of the button is a real image of the 2D image 122D of the button formed by the image transfer panel.

Using FIG. 4 and FIG. 5 described above, the control of the image control device 100 will be explained.

For example, it is assumed that the image control device 100 stores therein in advance a program for changing the 2D image related to each input display panel when the stereoscopic 2D image 313D of the button is pressed (or entered) by some detected object. At this time, using the image display apparatus 1 in the embodiment, the taken image related to each stereoscopic 2D image is obtained, regularly or irregularly. At this time, the position specification device as shown in FIG. 2 and FIG. 3 specifies the position in the space of the detected object 123 which enters, on the basis of the taken image. On the basis of the position of the detected object 123 specified in this manner, the image control device 100 judges whether or not the stereoscopic 2D image 313D of the button is pressed by the detected object 123. If it is not pressed by the detected object 123 (FIG. 4), nothing special happens. On the other hand, if it is pressed by the detected object 123 (FIG. 5), the display devices related to the plurality of input display panels are controlled to change the plurality of 2D images such that the button moves away from the detected object 123 in the z direction. This shows, for example, the transfer of the button in the depth direction. Moreover, at this time, in order to exaggerate perspective, the size of the 2D image 122D of the button may be set smaller than that of the 2D image 112D of the button. At this time, in addition, the 2D images 112D and 122D of the button may be transformed (e.g. dented), or sound effects may be enabled.

As described above, according to FIG. 4 and FIG. 5, the position of the detected object 123 which enters the space in which the stereoscopic 2D image (e.g. the stereoscopic 2D image 313D of the button) is displayed is preferably specified, and the plurality of 2D images are changed in accordance with the specified position of the detected object 123. Thus, the richer expression and interactivity can be attained.

### (2) Second Embodiment

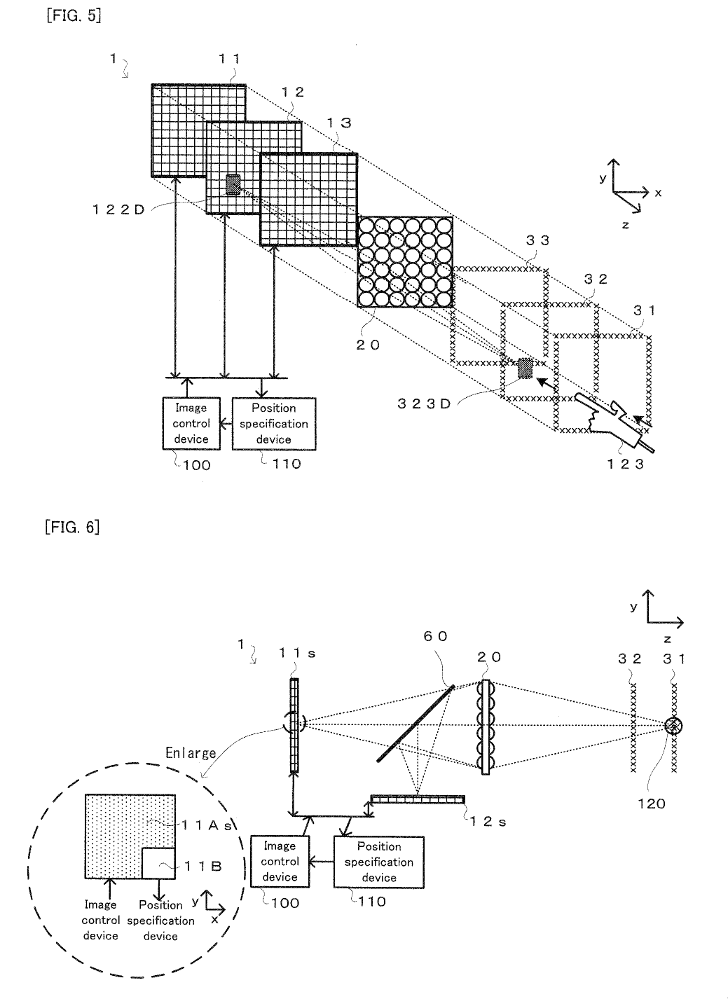

Next, the basic structure and operation process of the image display apparatus 1 in a second embodiment will be described with reference to FIG. 6. FIG. 6 is a schematic diagram conceptually showing the basic structure of the image display apparatus 1 in the second embodiment. Incidentally, in FIG. 6, the same structure as that of FIG. 1 carries the same numerical reference, and the detailed explanation thereof will be omitted, as occasion demands.

In FIG. 6, the image display apparatus 1 in the embodiment is provided particularly with: input display panels 11s and 12s; and a half mirror 60 as the “optical path combining/dividing device”.

The input display panels 11s and 12s are preferably input display panels of a light-emitting type, like an organic EL, and they are arranged such that their optical axes cross each other at substantially right angles. As described above, if the input display panels do not overlap on one optical axis, layout restrictions are eased if they are of a light-emitting type. Of course, if the ease of the restrictions is not expected, a plurality of backlights may be disposed on the back surface of each input display panel of a non-light emitting type.

The half mirror 60 is disposed on a substantially intersection of the optical axes related to the 2D images displayed on the screens of the input display panels 11s and 12s. The half mirror 60 is adapted to transmit the display light from the input display panel 11s and reflect the display light from the input display panel 12s, to thereby combine the two display lights on one optical axis extending toward the convex lens array 20 and display the stereoscopic 2D images 31 and 32 in a multilayer manner. On the other hand, the light from the detected object 120 is divided by the half mirror 60 into a light for the input display panels 11s and a light for the input display panel 12s, which are recognized through each imaging device.

As explained above using FIG. 6, the image display apparatus 1 in the embodiment uses the input display panels 11s and 12s of a light-emitting type and the half mirror 60, so that the degree of freedom of layout is increased. In addition, for example, such an arrangement that the light forming the 2D image related to the input display panel 11s goes around the input display panel 12s can be made, and the input display panel 12s does not always have to transmit the light. Incidentally, even in the embodiment, it should be understood that the plurality of input display panels can be arranged in a multilayer manner.

Incidentally, the present invention is not limited to the aforementioned embodiments, but may be changed, if necessary, without departing from the gist or idea of the invention, which can be read from all the claims and the specification thereof. The image display apparatus with such a change is also included in the technical scope of the present invention.

### INDUSTRIAL APPLICABILITY

The image display apparatus of the present invention can be applied to an image display apparatus capable of displaying a stereoscopic two-dimensional image and suitable for specification of the position of a detected object, which enters a space in which the stereoscopic two-dimensional image is displayed.

1. An image display apparatus comprising:
a plurality of displaying devices, each displaying device having a display screen, each displaying device displaying a two-dimensional image on the display screen, said display devices being arranged such that optical paths of display lights, which constitute the two-dimensional image, overlap each other;
an image transfer panel disposed on the optical path and transmitting the display light so as to display an image of the two-dimensional image in a space on an opposite side to the display screen;
an imaging device disposed integrally with or adjacent to the display screen, which is owned by each of said plurality of display devices, said imaging device imaging a detected object which enters the space through said image transfer panel;
a position specifying device for specifying a position in the space of the imaged detected object, on the basis of a result of the imaging by said imaging device; and
an image controlling device for controlling said plurality of display devices to change the two-dimensional images, on the basis of the specified position.

2. The image display apparatus according to claim 1, wherein said position specifying device specifies an in-plane position on an imaging plane on which the image is formed, in the space of the imaged detected object.

3. The image display apparatus according to claim 1, wherein said position specifying device specifies a position in a direction along the optical path, in the space of the imaged detected object.

4. The image display apparatus according to claim 1, wherein said plurality of displaying devices can transmit light at least partially and overlap at predetermined distance intervals in a direction along the optical path.

5. The image display apparatus according to claim 1, further comprising a light combining/dividing device for combining the display lights traveling toward said image transfer panel from each of the display screens and for dividing light traveling toward each said imaging device from the detected object.

6. The image display apparatus according to claim 1, wherein
at least one portion of said plurality of displaying devices is of a non-light-emitting type and can transmit light at least partially, and
said image display apparatus further comprises a backlight for emitting light toward the at least one portion from an opposite side to said image transfer panel.

7. The image display apparatus according to claim 1, wherein at least one portion of said plurality of displaying deices is of a light-emitting type.
